(19) United States
(12) Patent Application Publication
(10) Pub. No.: US 2011/0153803 A1
(43) Pub. Date: Jun. 23, 2011

(54) System and Method for Enforcing Device Service Eligibility

(76) Inventors: Richard KUO, Mountain View, CA (US); James Fan, San Ramon, CA (US); Patrick Martin, Woodstock, GA (US); Timothy Sperier, Alpharetta, GA (US)

(21) Appl. No.: 12/641,774

(22) Filed: Dec. 18, 2009

(51) Int. Cl. G06F 15/173

(52) U.S. Cl. 709/224

(57) ABSTRACT

A network component includes a device analyzing module and a functionality analyzing module. The device analyzing module analyzes first attributes related to a mobile device. The first attributes are associated with a device profile. The functionality analyzing module analyzes second attributes related to the mobile device. The second attributes are associated with a service profile. The analyses of the device profile and the service profile indicate whether the mobile device is operable to execute a requested service.

### BACKGROUND

As electronic technology continues to advance, more versatile devices are being developed and promoted on the market. The devices may range from a cell phone, personal digital assistant, netbook, notebook, and desktop computer, each with its own functionalities. However, the advancement of electronic technology has allowed one device to be able to perform functionalities of other devices. For example, a handheld device may now have capabilities that only a desktop computer was able to perform previously. At the same time, the technology also pushes various types of network capability upward to accommodate the improved conditions of the electronic devices. For example, electronic signals may be delivered farther and higher bandwidth may be delivered on new and different network media.

Currently, device capabilities and functionalities are mainly grouped by an International Mobile Equipment Identity (IMEI) standard including supported radio frequencies (e.g., 1900, 850, 900, 1800), wireless network technology type (e.g., GPRS), and push-to-talk. However, the attributes used to classify devices mainly focus on the network type and do not cover the functionalities and capabilities of devices themselves, whether the devices are the newest on the market with all available functionalities or an older model that is upgradable to support current functionalities.

The IMEI code has an association with a Store Keeping Unit (SKU) code which is a unique identifier for each distinct product and service used for inventory tracking. Although the SKU code describes some characteristics of a product or service, the current device classification scheme does not completely describe the actual device functionalities and/or capabilities. Consequently, difficulties arise for Business Support Systems (BSSs) and/or Operating Support Systems (OSSs) to support service eligibility checking and auditing activities.

### SUMMARY OF THE INVENTION

The exemplary embodiments describe a network component that comprises a device analyzing module and a functionality analyzing module. The device analyzing module analyzes first attributes related to a mobile device. The first attributes are associated with a device profile. The functionality analyzing module analyzes second attributes related to the mobile device. The second attributes are associated with a service profile. The analyses of the device profile and the service profile indicate whether the mobile device is operable to execute a requested service.

### DESCRIPTION OF THE DRAWINGS

FIG. 1 shows a network according to an exemplary embodiment.

FIG. 2 shows a server for the network of FIG. 1 according to an exemplary embodiment.

FIG. 3 shows a method for establishing capabilities of a mobile device to determine if a requested service may be rendered thereon according to an exemplary embodiment.

### DETAILED DESCRIPTION

The exemplary embodiments may be further understood with reference to the following description and the appended drawings, wherein like elements are referred to with the same reference numerals. The exemplary embodiments describe a system and method for enforcing device service eligibility. Specifically, the system may determine the functionalities with which a mobile device is equipped so that a determination may be whether to render a service request. The system, the eligibility, the functionalities, the mobile device, the service request, and a related method will be discussed in further detail below.

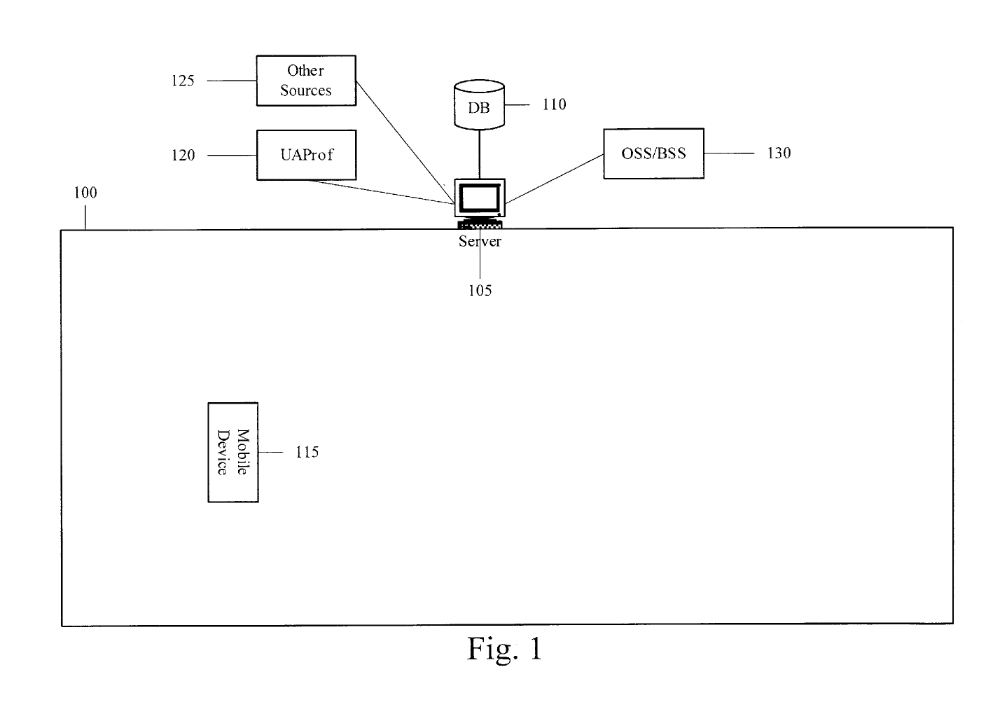

FIG. 1 shows a network 100 according to an exemplary embodiment. The network 100 may enable mobile devices to connect thereto so that mobile services may be provided. The network 100 may include a variety of different types of networks such as 2G, 3G, and long term evolution (LTE). Accordingly, mobile services in which the different types of networks support may be provided to the mobile devices. As will be discussed in further detail below, the exemplary embodiments provide a means to determine whether a requested service may be rendered for a mobile device as a function of the functionalities that the mobile device itself supports. Furthermore, a preliminary determination may be made whether the network 100 supports the requested service. The network 100 may include a server 105 and a database 110 in which a mobile device 115 may be disposed within the network 100. The server 105 may further have access to a User Agent Profile (UAProf) database 120 and other sources 125.

It should be noted that the network 100 may include further components. For example, the network 100 may include cell stations, access points, etc. The cell stations may provide a coverage area in which a type of network (e.g., 2G, 3G, LTE) is provided. The cell stations and/or access points may also increase an overall coverage for the network 100. Thus, the mobile device 115 may be disposed within a coverage area of a cell station which relays signals to the server 105.

The server 105 and the database 110 may provide conventional functionalities for the overall network 100. As will be described in further detail below, the server 105 may also be configured to identify which device supports which specific service feature. Accordingly, the server 105 may break down a device's capability into identifiable functions. For example, the functions may be linked to service features that are planned to be offered based on a marketing prospective. Thus, the server 105 may identify hardware and/or software installed on, for example, the mobile device 115 to at least provide a basis to determine the various functionalities capable thereby. Other identifiable functions may include whether a functionality is for communication (e.g., voice, messaging, etc.), whether a functionality is for entertainment (e.g., gaming, multimedia, etc.), whether a functionality is for information, (e.g., location, ebook, directory, etc.), whether a functionality is for finance (e.g., banking, payment, etc.), etc. Since the server 105 provides the conventional functionalities of the network 100, the server 105 may also already be aware and/or determine supported functionalities for the network type in which the mobile device 115 is disposed.

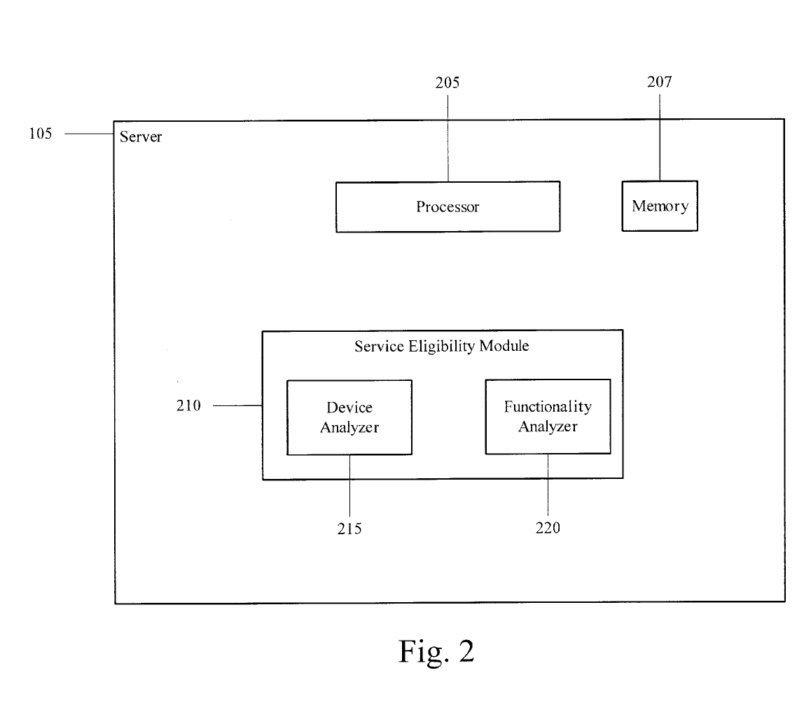

FIG. 2 shows the server 105 for the network 100 of FIG. 1 according to an exemplary embodiment. The server 105 may include a processor 205, a memory 207, and a service eligibility module 210. The processor 205 may execute processes related to the conventional functionalities that the server 105 provides for the network 100 while the memory 207 may store data for the server 105. It should be noted that the service eligibility module 210 being disposed as incorporated with the server 105 is only exemplary. In another exemplary embodiment, the service eligibility module 210 may be a modular device that connects (e.g., universal bus (USB) connector, wirelessly, etc.) to the server 105.

The service eligibility module 210 may include a device analyzer 215 and a functionality analyzer 220. According to the exemplary embodiments, device analyzer 215 may analyze data relating to hardware of the mobile device 115. In a first example, the device analyzer 215 may have access to the UAProf 120 to identify associated functionalities of the mobile device 115 based upon the hardware of the mobile device 115. The UAProf 120 may be a database that stores an established industry standard to define device functions. That is, the UAProf 120 may be a specification that is used to capture the capability and preference for mobile devices such as the mobile device 115. Those skilled in the art will understand that the UAProf 120 is mainly used by service providers to manage and to deliver the content in a proper format for a particular mobile device. The service eligibility module 210 may use the UAProf 120 as a basis with an addition of further requirements to establish the capabilities of the mobile device 115.

The UAProf 120 may be maintained by receiving data from device vendors. The UAProf 120 for an individual mobile device may also be in an XML format, thereby enabling an extension for future needs such as including a further functionality when the mobile device 115 is upgraded. Therefore, a device profile may be established by extending an existing UAProf 120 of the mobile device 115 with additional attributes needed from operation and an asset management perspective (e.g., status of leasing, device refurbish, etc.). Thus, the device profile may enumerate the hardware components of the mobile device 115 to partially establish the functionalities capable thereby.

According to the exemplary embodiments, the functionality analyzer 220 may analyze data relating to services already capable by the mobile device 115. The functionality analyzer 220 may access a service profile for the mobile device 115. The above described device profile may be a static profile that is normally unchanged unless by providers of the data (e.g., UAProf data). However, those skilled in the art will understand that there are times when certain attributes in the device profile may be deactivated, thereby giving an appearance that a requested service may not be rendered despite the mobile device 115 having the capability otherwise. When a new service is requested, the service eligibility module 210 may initially perform a hardware analysis via the device analyzer 215 to determine the capability in the device profile. If an initial analysis of the device profile indicates that the mobile device 115 does not have a proper combination of attributes, the service eligibility module 210 may initially indicate that the service is unavailable for the mobile device 115.

The service eligibility module 210 may subsequently perform a functionality analysis via the functionality analyzer 220 to determine the capability in the service profile. As stated above, the mobile device 115 may be configured to support the requested service but the device profile may indicate to the contrary. An analysis of the service profile may therefore correct the determination from the analysis of the device profile alone. The device profile may be updated when such a determination is made. The device profile and the service profile may be stored in the database 110. Thus, in combination with the device analyzer 215, the service eligibility module 210 may be configured to determine whether a requested service may be rendered on the mobile device 115.

In an exemplary embodiment of the service eligibility module 210 identifying the functionalities supported by the mobile device 115, the service eligibility module 210 may initially access the IMEI of the mobile device 115. The IMEI may provide a basis with which to determine the UAProf-ID stored in the UAProf 120. The UAProf-ID may be used to retrieve all of the capabilities of the mobile device 115 from a repository, such as when the data is stored in the database 110. In addition to the UAProf-ID, the service eligibility module 210 may further consider other factors such as a functionality itself enumerated in the service profile with its respective characteristics. For example, a functionality of the mobile device 115 may be TurnByTurn which requires further capabilities such as a GPS, a map, SMS, a keypad, etc. The service eligibility module 210 may additionally use characteristics of a functionality to further determine the capabilities of the mobile device 115. The service eligibility module 210 may access the database 110 and/or the other sources 125 for information relating to the functionalities.

According to the exemplary embodiments, a device function repository may be stored in the database 110 or accessed via the other sources 125. The service eligibility module 210 of the server 105 may, therefore, provide a more detailed device description to itemize each device capability such as those of the mobile device 115. The industry standard UAProf-ID's stored in the UAProf 120 may be leveraged to provide a basis for determining the functionalities of the mobile device 115. The database 110 or other sources 125 may also store an existing device table which may further contribute and/or merge with the device function repository. As discussed above, a functionality of the mobile device 115 may provide further data relating to other functionalities of the mobile device 115. Thus, using the device profile (e.g., defined from a UAProf basis) and the service profile (e.g., other existing data of the mobile device 115), the service eligibility module 210 may determine the capabilities of the mobile device 115.

The database 110 may also store a service feature and device support requirement map. As discussed above, all service features may be grouped into manageable categories. Each category may be described by a list of required device capabilities. A sub-category may contain features that are always or frequently grouped with another feature. As discussed above, the turnByTurn feature usually requires a GPS, a map, SMS, a mapserver, a keypad, etc.

The above description relates to the mobile device 115 that has already been deployed in the network 100. Thus, the user of the mobile device 115 may request a service. The service may be requested using a variety of methods. For example, the mobile device 115 may include an option to expand the functionalities. In another example, the user may visit a service center for the mobile device 115. Accordingly, it is noted that whether the mobile device 115 is deployed in the network 100 is irrelevant as the service eligibility module 210 is capable of determining whether a requested service is able to be rendered using the device profile and the service profile.

Other features for the exemplary embodiments may include marketing offers that may be restructured to act as a container for other attributes such as a device, a service, a promotional period, a rate plan, a market, any business rules specifically for each offer, etc. Because the capabilities of the mobile devices may be tracked centrally at through the device profile, marketing and sales departments may be able to consider the capabilities for marketing aspects.

In another example, after the capabilities of the mobile device and service features are established, a usage monitoring software package may be developed to access static data that resides in an enterprise database for analysis. Accordingly, promotional and/or upgrade rules may be tracked and allow service providers to be aware of when a promotion is to be made or when an upgrade is to be allowed. Accordingly, referring back to FIG. 1, the server 105 may be connected to an OSS/BSS 130 to support the above described features.

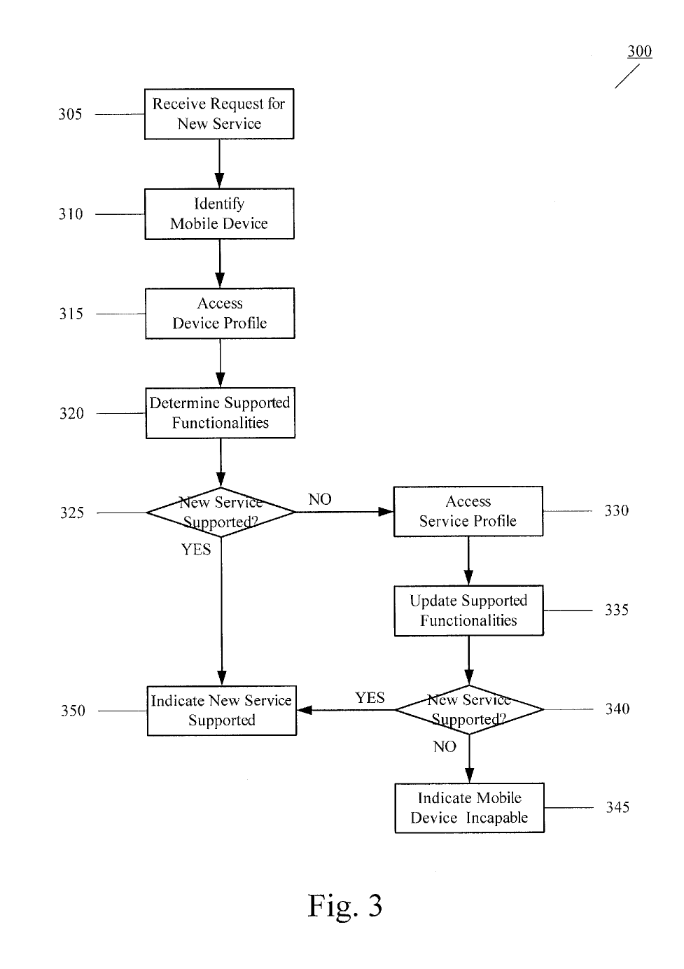

FIG. 3 shows a method 300 for establishing capabilities of a mobile device to determine if a requested service may be rendered thereon according to an exemplary embodiment. The method 300 may be used to track the functionalities that the mobile device is capable of performing. The method 300 will be described with reference to the network 100 of FIG. 1 and the server 105 of FIG. 2.

In step 305, the service eligibility module 210 receives a request for a new service from the mobile device 115. As discussed above, the new service may be requested using a variety of methods. In a first example, the mobile device 115 may be configured with a new service option to enable a user to directly request the new service from the mobile device 115 itself. In a second example, the user may visit a service center that may receive the new service request and forward the request to the service eligibility module 210.

In step 310, the service eligibility module 210 determines an identity of the mobile device 115 that is disposed in the network 100. The identity of the mobile device 115 may be determined using a variety of methods. For example, a signal received from the mobile device 115 may include an identifying header that denotes, for example, a manufacturer, a model number, etc.

In step 315, the device analyzer 215 accesses the device profile for the mobile device 115. As discussed above, the device analyzer 215 may access the UAProf 120 to retrieve a UAProf-ID for the mobile device 115 based upon the identity thereof. The UAProf-ID may include capabilities and/or preferences for the mobile device 115. The device profile may be established from using the UAProf-ID in addition to other sources. In step 320, the device analyzer 215 may determine supported functionalities of the mobile device 115 based upon the device profile. That is, the supported functionalities determined in step 320 may be from the hardware components of the mobile device 115.

In step 325, the service eligibility module 210 determines whether the new requested service is supported by the mobile device 115. Based on the functionalities determined in step 320 from the device profile, the service eligibility module 210 may make the determination. If the new requested service is supported by the mobile device 115, the method 300 continues to step 350.

If the new requested service is not supported by the mobile device 115 based upon the analysis of the device analyzer 215 from the device profile, the method 300 continues to step 330. In step 330, the functionality analyzer 220 accesses the service profile for the mobile device 115. As discussed above, the service profile may enumerate the functionalities of the mobile device 115. The functionality analyzer may use the service profile of the mobile device 115 to determine if the mobile device 115 may be capable of supporting the new requested service despite the device profile indicating the contrary. For example, the device profile may have a hardware of the mobile device 115 shown as deactivated, thereby not registering the component. However, the service profile may be used to determine that the mobile device 115 includes a functionality that must use the deactivated component, thereby the functionality analyzer determining that the component exists.

In step 335, the functionality analyzer 220 updates the functionalities of the mobile device 115. That is, if the functionality analyzer 220 has determined that further functionalities are supported, the device profile may subsequently be updated to indicate that services using the updated components are also supported.

In step 340, another determination is made by the service eligibility module 210 whether the new requested service is supported by the mobile device 115 based upon the enumerated services established from the device profile and the service profile. If the new service is still not supported, the method 300 continues to step 345 where an indication is generated to show that the mobile device 115 is incapable of supported the requested service. If the new service is determined to be supported from the updated device profile, the method 300 continues to step 350. In step 350, an indication is generated to show that the mobile device 115 supports the requested service.

The exemplary embodiments provide for enumerating supported functionalities of a mobile device using a device profile and a service profile thereof. A server of a network may include a service eligibility module that generates the list of supported functionalities. The device profile may be a static list of hardware components of the mobile device. The service profile may be a dynamic list of functionalities of the mobile device. The combined analysis of the device profile and the service profile may accurately determine whether a requested service may be rendered on the mobile device by generating a complete list of supported functionalities of the mobile device. The service eligibility module may access a UAProf-ID of the mobile device as well as other device attributes. From the information contained therein, the service eligibility module may determine the device profile.

The device profile that is generated may enable an extended data schema to describe capabilities available on the mobile device as well as potentially available. The device profile may also be updated using the service profile for future reference. The device profile may enable a comprehensive service offer description schema that allows various telecom services to be added or modified on the mobile device without concern for an actual implementation. A flexible device capability description schema may be used to connect service offers for marketing and/or sales departments. Thus, the marketing and/or sales departments may be equipped to quickly respond to marketing needs. Access to the device profile may further enable backend systems to monitor and different quality of service (QoS) and service level agreement (SLA) to be audited based on service offers and device capabilities, thereby improving service quality and customer satisfaction. The device profile may additionally provide a usage pattern associated with a mobile device to be analyzed so that a proactive identification for new needs may be done. Notifications may also be provided to customers to inform them of better service plans or upgraded plans when considering the device profile.

Those skilled in the art will understand that the above described exemplary embodiments may be implemented in any number of manners, including, as a separate software module, as a combination of hardware and software, etc. For example, the service eligibility module 210 may be a program of the sever 105 containing lines of code that, when compiled, may be executed on the processor 205.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A network component, comprising:
a device analyzing module analyzing first attributes related to a mobile device, the first attributes being associated with a device profile; and
a functionality analyzing module analyzing second attributes related to the mobile device, the second attributes being associated with a service profile,
wherein the analyses of the device profile and the service profile indicate whether the mobile device is operable to execute a requested service.

2. The network component of claim 1, wherein the network component is a server of a network in which the mobile device is disposed.

3. The network component of claim 1, wherein the device analyzing module and the functionality analyzing module are incorporated with the network component.

4. The network component of claim 1, wherein the device analyzing module and the functionality analyzing module are connected to the network component.

5. The network component of claim 1, wherein the device profile is at least partially generated from a user agent profile (UAProf).

6. The network component of claim 5, wherein the UAProf defines device functionalities and preferences for the mobile device.

7. The network component of claim 5, wherein the service profile defines functionalities already incorporated with the mobile device.

8. The network component of claim 7, wherein the network component determines a first set of functionalities based upon the device profile.

9. The network component of claim 8, wherein the network component determines a second set of functionalities based upon the service profile.

10. The network component of claim 1, wherein the functionalities are grouped into subcategories including at least one of communication, entertainment, information, and finance.

11. A method, comprising:
analyzing, by a device analyzing module of a network component, first attributes related to a mobile device, the first attributes being associated with a device profile;
analyze, by a functionality analyzing module of the network component, second attributes related to the mobile device, the second attributes being associated with a service profile; and
determine, by the network component, whether the mobile device is operable to execute a requested service as a function of the analyses of the device profile and the service profile.

12. The method of claim 11, wherein the network component is a server of a network in which the mobile device is disposed.

13. The method of claim 11, wherein the device analyzing module and the functionality analyzing module are incorporated with the network component.

14. The method of claim 11, wherein the device analyzing module and the functionality analyzing module are connected to the network component.

15. The method of claim 11, wherein the device profile is at least partially generated from a UAProf.

16. The method of claim 15, wherein the UAProf defines device functionalities and preferences for the mobile device.

17. The method of claim 15, wherein the service profile defines functionalities already incorporated with the mobile device.

18. The method of claim 17, further comprising:
determining, by the network component, a first set of functionalities based upon the device profile.

19. The method of claim 18, further comprising:
determining, by the network component, a second set of functionalities based upon the service profile.

20. A network component, comprising:
a device analyzing means for analyzing first attributes related to a mobile device, the first attributes being associated with a device profile; and
a functionality analyzing means for analyzing second attributes related to the mobile device, the second attributes being associated with a service profile,
wherein the analyses of the device profile and the service profile indicate whether the mobile device is operable to execute a requested service.
